(19) United States
(12) Patent Application Publication
(10) Pub. No.: US 2008/0238971 A1
(43) Pub. Date: Oct. 2, 2008

(54) Method of Selecting Objects To Be Printed For A Hand-Held Printer

(76) Inventors: Brian Dale Cook, Nicholasville, KY (US); Douglas Laurence Robertson, Crestwood, KY (US); Barry Baxter Stout, Lexington, KY (US)

Correspondence Address: Neill R. Kahle, Jr.;Lexmark International, Inc., Intellectual Property Department, 740 West New Circle Road, Lexington, KY, 40550, US

(21) Appl. No.: 11/693,791

(22) Filed: Mar. 30, 2007

(51) Int. Cl. B41J 29/38; B41J 3/36

(52) U.S. Cl. 347/14; 347/109

(57) ABSTRACT

Methods for selecting elements of information displayed on a computer screen for printing by a hand-held printer that preferably incorporates the capability of a computer mouse to more efficiently capture and print such information thereby minimizing the time and effort required for printing such information.

### FIELD OF THE DISCLOSURE

The disclosure relates to several different methods for easily selecting elements of a display on a computer screen for printing by a hand-held printer, and, in particular, to provide a more efficient manner of printing for a hand-held printer user whereby only needed information is selected, thereby minimizing the time required and effort in printing.

### BACKGROUND OF THE INVENTION

While a hand-held printer can be a great solution for mobile printing, such printers generally require more time and effort from a user. Because such hand-held printing is a time intensive task, and the user has to physically move the printer, it is desirable to limit the printed content to only those items which the user deems to be necessary to have printed.

Because hand-held printing is a relatively new concept, there is little software on the market that specifically addresses this type of printing. With a standard printer, printing a web page from a website is as easy as selecting the “printer friendly” format on the site, and then selecting “print” through the browser. Any extraneous printed content such as ads, menu items, hotel suggestions, etc. are of little consequence with a standard printer because such materials take only a marginal amount of extra ink and time in printing. However, with a hand-held printer, printing such extraneous items wastes valuable time and requires wasted effort to print such needless data.

One important consideration in using hand-held printers is the convenience in selecting the data to be printed, and subsequently printing such data. This is especially important for the business traveler who frequently needs to print data appearing on a computer screen such as data being processed in the computer or information appearing on a webpage. Having a hand-held printer which is operative to select only the desired content from a computer screen which is to be printed, and then printing the selected copy provides a very efficient and time saving manner for the business traveler when out of or away from the office.

### SUMMARY OF THE INVENTION

Accordingly with regard to the foregoing and other objects and advantages, this invention is directed to apparatuses and methods for utilizing a hand-held printer to select for copying only that material from a computer screen that is intended to be printed, in the manner such as a computer mouse is used, and then printing such selected information onto a desired medium through operation of the hand-held printer. Such a device can be either tethered to a computer or utilize a wireless connection whereby the communication between the hand-held printer and the host computer may be coupled thereto such as by Bluetooth or Wi-Fi. Some embodiments of this invention provide methods of selecting desired information from the information displayed on a computer screen by operating a hand-held printer in a “mouse” mode to copy such desired information and then switching the printer into a “printer” mode for printing just that desired information selected from the computer screen while the printer was operating in the “mouse” mode.

### BRIEF DESCRIPTION OF THE DRAWINGS

Further features and advantages of the disclosed embodiments may become apparent by reference to the detailed description when considered in conjunction with the figures wherein like reference numbers indicate like elements throughout and wherein:

FIG. 1 is a representation of a laptop computer having tethered thereto a hand-held printer having two modes of operation, a mouse mode and a printer mode;

FIG. 2 is a representation of a wireless version of a hand-held printer operating in a printer mode to transfer data previously selected from a computer screen and being printed onto a print-receiving medium;

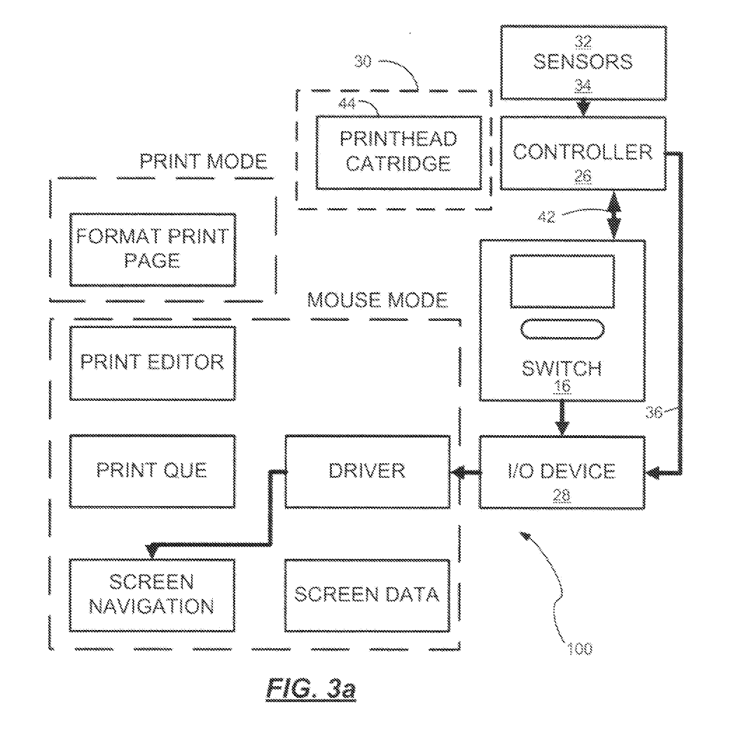

FIGS. 3a and 3b are general diagrammatic representations of a hand-held printer wherein FIG. 3a illustrates the hand-held printer operating in a capture or normal mouse navigation mode to select text or graphics prior to sending the selected data to a print buffer or effecting printing of the selected materials, and FIG. 3b illustrates the hand-held printer in the mouse-printer mode wherein the captured data is formatted and printed by the hand-held printer, and

FIG. 4 is a state flow diagram of the method for operating the hand-held printer in a mouse mode for selecting data from a computer screen, and then printing such selected data when the hand-held printer is operating in a printer mode, onto a print-receiving medium.

### DETAILED DESCRIPTION

In meeting the needs of the business traveler for on-the-go access to data and a manner in which such data can be organized and presented in hard-copy form, hand-held printers have been developed. Such hand-held printers enable a user to create hard-copy materials for distribution or presentations without the necessity of locating a printer with which the business traveler's computer can communicate in order to provide a print copy. Such hand-held printers are moved manually over a print medium such as paper or other such surface upon which the information to be printed lies, without the aid of a drive mechanism for positioning a print head relative to the print medium, relying instead on the motive force exerted via a user's hand. One or more sensors affixed to the hand-held printer sense the position of the print medium as it moves and a controller in the printer activates printing whenever of the area under the print element matches an unprinted section of a latent image, i.e., the portion of the image yet to be printed.

Typically an optical encoder is used to provide position feedback of relative motion between the hand-operated printer and the print medium. A hand-held or hand-operated printer navigates by continually updating its position with calculations of data from sustained sampling of information, and requires the printing of multiple swaths of print data over multiple passes of the hand-held printer over the print medium to complete a document page. Accordingly, hand-held printers are often used for printing small amounts of data, and it is highly desirable to be able to selectively retrieve only desired portions of information from a larger amount of data for presentation in a manner most useful to a particular application.

For example, it is desirable that a user could call up a particular website on a laptop computer, such as a map, and select only the telephone number and the business hours of operation from the information displayed on the screen. Accordingly, a hand-held printer, using the same encoders as a computer mouse, may be operated in a “mouse” mode whereby movements of the hand-printer are communicated to the lap top and used by the lap top to highlight and select to-be-printed data. In some embodiments, the selected information that is to be printed is transferred to and stored in a memory of the hand-printer while the printer is operating in its mouse mode. The hand-printer is then switched into its second mode, or its “print” mode, and the transferred information is printed onto a media.

Accordingly, in some embodiments of the invention a single hand-held device functions as a mouse in a first mode and as a hand-printer in a second mode. When in the mouse mode, the location and movement of the device is transmitted to a lap top or other hose system and used to move a cursor on a monitor and to capture to-be-printed data. But when in its printer mode,

This invention presents new techniques for choosing the content to print on a computer screen which can take into account benefits from the printer having a mouse mode in addition to a printer mode. Having such a dual mode operation in a hand-held printer greatly compliments the solutions presented. For example, two USB subdevices may be used in a device referred to as a combined mouse-hand-held printer. All USB products share the same physical connection, but there are many different communication protocols for different purposes. Most of the differences center on how packets of information are sent from the product to the host computer. Also, there are methods of routing many USB devices through one product such as a USB hub, where each separate function gets a different interface. Because USB communication is serial, the USB host controller polls the bus in a round-robin fashion, looking for transfer requests by priority. Each device has only one “device descriptor” which in turn has one or more “configuration descriptors” that shows the mode like active or low power. Each “configuration descriptor” has one or more “interface descriptors” which describes the different communication routes of the device and how to use the endpoint. An endpoint relates to a sub device of the main device, and multiple endpoints can be used, too.

A simple USB device has only one interface to one end point such as a mouse or keyboard. Other more complicated devices may have several interfaces, such as a printer which has a different interface for the scanner, flash card reader, fax, and print engine. In a mouse-printer, each interface is called a function or device within the main product. One cord attaches all these devices to a host computer, but within the one connection are multiple pipes or endpoints. Each different pipe or endpoint allows the host computer to communicate to every device separately within the product through its end point number. The interface enables communication with a sub device, and the endpoint is the communication terminal. There are a total of 32 endpoints available with 16 going from host to product, and 16 traveling from product to host. End point 0 is reserved for bus management.

Each pipe can be configured in one of four ways. The two protocols for printers and pointing devices (computer mice) are: interrupt transfers and bulk transfers. Interrupt transfers allow small packets to be exchanged with a bounded latency. This works well for a mouse where the position needs to be transferred at a guaranteed rate, but the amount of information is very small. On the other hand, bulk transfers use all the remaining bandwidth for transferring large amounts of information sporadically. This is used for large file transfers such as bitmap information going to the printer.

It is common practice to support multiple pipes within one USB product of the same interface type. Even though USB hubs support multiple interface types, they do not set up the interface types—only route them. The hand-held printer of this application combines both of these functions. It first sets up different types of interfaces like a printer, and then it puts the different pipes through one connection like a USB hub. In this case, it sets up the mouse part of the hand-held printer to be interrupt transfer base, and it sets the print part to be bulk transfer based, all going through the same USB cable. In this application, the end point configuration routine in the hand-held printer creates the mouse protocol through the Interface Descriptor by setting the bInterfaceClass variable to 0×03. This allows the host PC to recognize that specific end point as a HID (Human Interface Device). While most USB controllers in computer mice set the communication bInterface Device class, this will not work in this application because the mouse portion of the printer is not the only USB interface for the hand-held printer.

While an interrupt transfer based protocol is the best method for setting up the mouse portion of the hand-held printer, problems arise that this protocol requires a constant stream of information to the host computer. If the host computer does not see a signal, then it thinks the device is unconnected and unmounts the end point. In the case of the hand-held printer, putting the printer in “printing” mode disables the mouse position information from reaching the host. One method of preventing this problem is to use peripheral emulation which provides a fake signal to the host computer that the device remains enabled. In such an embodiment, the hand-held printer will still send packets of data to the host in print mode, but the data will contain zeros correlating to no movement.

As previously stated, the printer portion of the hand-held printer utilizes bulk transfer protocol. This needs minimal feedback to maintain the end point, unlike the interrupt transfer based protocol. The key for the printer portion is setting up the proper speed. While the mouse portion (interrupt transfer protocol) defaults at a low speed, the printer portion tries to establish what is commonly referred to as full speed, if not high-speed. This requires having a transaction translator to handle the two different speeds. The translator will negotiate the fastest connection speed with the host PC, and either up sample or down sample all the pipe speeds to match.

Once the user plugs in the hand-held printer to the host PC, the mouse interface sets up as a HID, and the hand-held printer can be used as a mouse first by default. A background program monitors the user's movements, and waits until the user wants to print. Once the print sequence is started, the USB driver on the host PC tells the printer to enter “print” mode and emulate the mouse interface. Now the user moves the hand-held printer to produce a printout while the host PC gets zero position moved for its mouse feedback. The actual position feedback is used by the hand-held printer's embedded controller to trigger the host PC to send the bitmap information needed to printing. Once the user is either done with the printout, or cancels the operation, the position feedback once again channels through the mouse interface so the hand-held printer acts like a normal pointing device, or mouse.

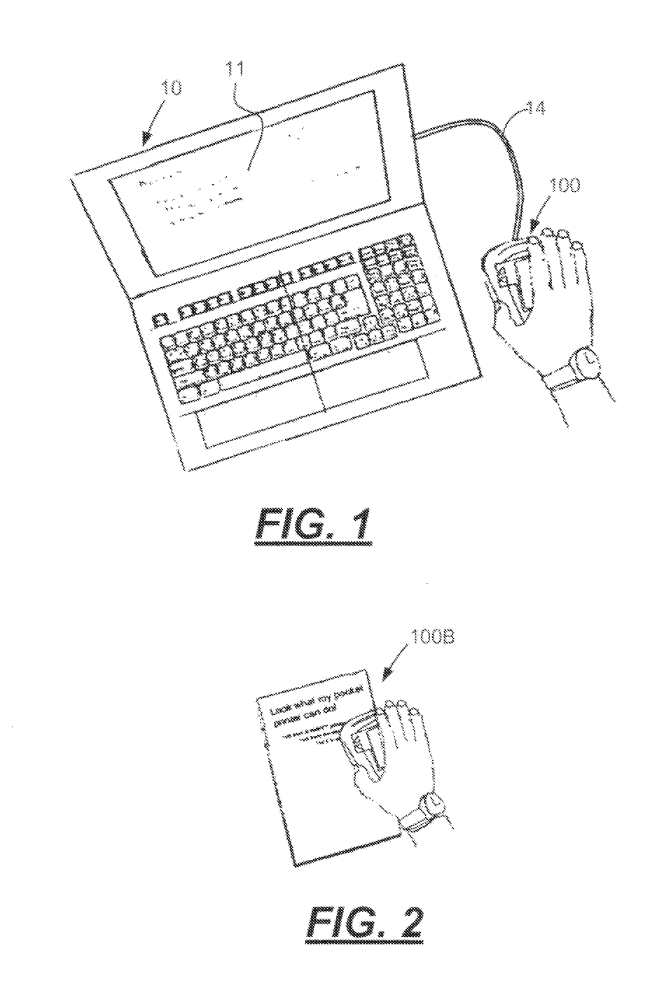

One of the purposes of a hand-held printer is to print small amounts of data, such as small files, on the go. Referring now to FIG. 1, there is illustrated a host computer 10 with a combination mouse-hand-held-printer 100 coupled thereto. For further information as to the manner in which such a mouse-printer 100 is constructed, and the manner in which said mouse-printer 100 functions to operate in these two modes, reference is made to co-pending application Ser. No. 11/312,105 filed Dec. 20, 2005 entitled “USER INTERFACE FOR A HAND-OPERATED PRINTER” and assigned to the assignee of this application, the disclosure of which is incorporated herein by reference.

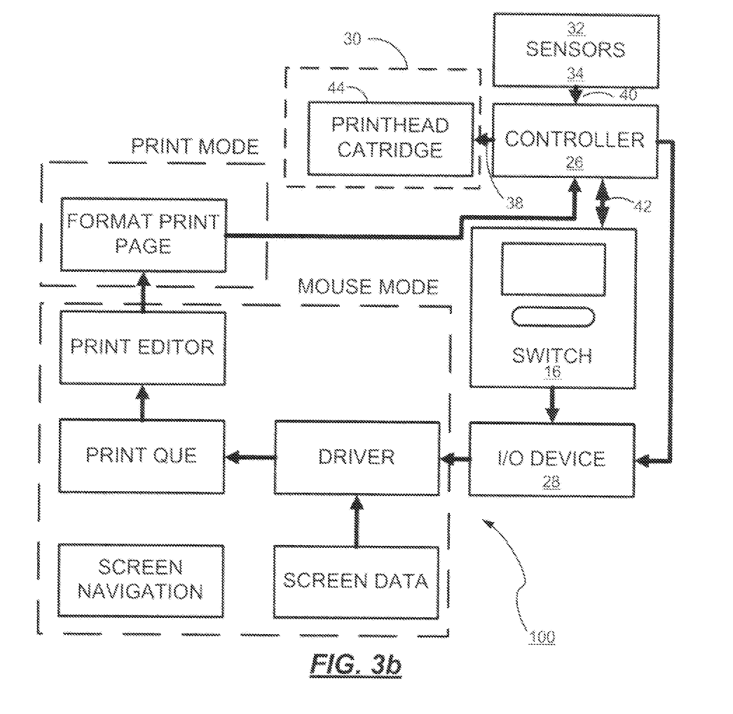

For purposes of illustration, a suitable ink jet hand-held mouse-printer 100 is illustrated diagrammatically in FIGS. 3a and 3b, and may include an operator panel 16, a controller 26, an input-output (I/O) device 28, a cartridge receptacle 30, a first sensor 32, and a second sensor 34. Each of operator panel 16, controller 26, I/O device 28, cartridge receptacle 30, and one or more sensors 32 and 34 mounted to the mouse-printer 100.

As used herein, the terms “first” and “second” preceding an element name, e.g., first sensor, second sensor, etc. are used for identification purposes to distinguish between similar elements, and are not intended to necessarily imply order unless expressly stated nor are the terms “first”, “second”, etc. intended to preclude the inclusion of additions similar elements, e.g. “third”, “fourth”, etc.

Controller 26 includes a processor unit and associated memory, and may be formed as one or more Application Specific Integrated Circuits (ASIC). Controller 26 executes program instructions to perform data processing and formatting, facilitate printing control, and/or facilitate device interaction with respect to one or more of a plurality of devices in communication with controller 26. Controller 26 is communicatively coupled to I/O device 28 via a communications link 36. Controller 26 is communicatively coupled to cartridge receptacle 30 via a communications link 38. Controller 26 is communicatively coupled to operator panel 16 via a communications link 42.

As used herein, the term “communications link” generally refers to structure that facilitates electronic communication between components, and may operate using wired or wireless technology.

I/O device 28 may be configured in a variety of ways, depending on the source and/or destination of the communicated content. For example, I/O device 28 may be a wired, e.g., USB or wireless, e.g., IEEE 802.XX, communication device that provides a communications link to a source of image content, such as for example, a memory card reader and associated memory card. Alternatively, I/O device 28 may provide a link to a host computer, or some other intelligent device that may supply image data for printing by hand-held printer 100.

Cartridge receptacle 30, for example, may be formed in body 12 and configured for receiving and mounting at least one print head cartridge 44 which includes an ink jet print head having an array of ink jetting nozzles and a supply of ink. Cartridge receptacle 30 holds print head cartridge 44 in a fixed position relative to hand-held printer 10 and print head cartridge 44, and is communicatively coupled to controller 26 via communications link 38.

Movement of the hand-held printer 100 relative to the print medium results in relative movement of print head cartridge 44 and its ink jet print heads with respect to the printing surface of the print medium. A smooth bottom surface of the hand-held printer contacts the print medium to provide a desired spacing between the ink jets of the print head and the printing surface of the print medium.

Capturing graphics and capturing text from the computer screen are two different challenges. Most operating systems like Microsoft Windows have the ability to highlight text in any program and capture the ASCI values. This allows text to be transferred from one program to the next without complicated translations. The user simply highlights the text, copies the text to the clipboard, and pastes the text into any other program such as an application that collects text and graphic elements. In the case where the user wants to keep the exact formatting and appearance of the text, then the copy operation is identical to copying graphic elements and the copy function treats the text as a picture.

In the case of graphic elements (everything but text) such as printers, there are many formats such as .jpg, .tiff, word art, etc. Therefore, there is no standard way of collecting this type of element. The easiest method to collect a graphic element is to perform some sort of screen capture. Most computer operating systems that are equipped with a monitor have some method of collecting the screen buffer or the image from the monitor. In some embodiments, a separate application captures the information from the screen capture operation and crops it using processes that are well known to those skilled in the art.

In one embodiment, a collection program is used to collect one or more graphic and text elements. In such an embodiment, a user selects only the elements that he or she desires to print from one or more web pages, applications, email or other sources of text and graphics. First the user identifies data that the user intends to print and uses a capture application to collect the to-be-printed elements. In some embodiments, such as the collection of text, the software required to collect the data are part of the operating system of the host system. In other embodiments, the capture software is a separate application residing on the host system that is launched by the user from the host, or optionally, from the hand-printer.

One or ordinary skill will readily recognize that the capture software can use any number of different user interfaces. For purposes of illustration, one can assume that the capture software allows the user to choose from a plurality of displayed elements those that the user desires to print. For example, a user might have the option to highlight selected text, or to lasso and drag and drop one or more of the displayed elements. In an exemplary embodiment, the capture software performs a screen capture and allows the user to lasso some or all of the displayed elements to select the element(s) to collect for printing the desired information. After all the desired elements are selected, the user might have the opportunity to organize the selected elements, to print the selected elements, or to return to the host computer wherein the user could launch a new web page or application from which the user could collect additional to-be-printed elements.

Another exemplary illustration will be used to describe the certain aspects of the invention. In this example, a user desires to print an address from an email. The user switches the hand-printing device to its mouse mode, causing the movement of the hand-printer to correspond to the movement of a cursor on a host computer. Using the hand-printer to guide the cursor, the user highlights the address and uses the copy and paste function of the host computer's operating system to paste the address on a clipboard.

Next, the user moves the hand-printer to cause the cursor to move over a Printer Center icon on the host computer, and the user presses a button on the hand-printer that corresponds to a right click of a mouse. In one embodiment, the hand-printer is equipped with a two or three-button architecture that mimics the standard button arrangement of a computer mouse. The right-click action activates the system tray, and three choices are displayed on the host monitor: “select text”, “select graphics”, or “print/edit buffer”.

The user selects one of the three options by moving the hand-printer so that the cursor is placed over the desired operation and initiates a function from the hand-printer that is received by the host and treated as a left-click of a mouse. For purposes of example, we assume that the user chooses “select text,” which causes the copied text (the address) from the clipboard to be placed into a collection of elements memory area, which may reside either in the memory of the hand-printer or, in some embodiments, in a designated area of the host computer.

To continue with the example, let's assume that the user finds a map of the city in which the to-be-printed address is located and wants to add it to the collection of to-be-printed elements. Again, the user uses the hand-held printer in mouse mode to send a right click to the host, while the cursor is over the Printer Center icon. When the three options are displayed, the user this time chooses “select graphics.” In this illustration, this choice causes a new window to appear on the host's monitor, the new window containing the data from a screen capture and a lasso or other graphics tool to allow the user to select, highlight or otherwise identify that portion of the screen capture data that the user wants to print. The user uses the lasso or other graphics tool to select the graphic element, which in this example is a map of the destination city. Once all the desired elements are selected, the user uses the hand-printer to left-click on a “complete” button to terminate the screen capture window and return to the host.

Once all of the to-be-printed elements have been captured and are added to the collection of elements (the phrase used herein to identify the collection of to-be-printed elements), the user optionally has the ability to organize the elements. Again, the user interface for organizing the elements can take any of a number of different forms, but for purposes of illustration will take the form of a window that displays the elements in the collection and allows the user to create a preferred layout for the print. Most likely, the organization window will include standard options such as the ability to change the font of text or to manipulate the size and shape of the collected text and images.

If the collection of elements is stored on the host memory area or a host buffer, an additional step that transmits the to-be-printed to the hand-held device occurs. Several factors will determine whether the data is stored on the host or the hand-held device during the collection processes, including, without limitation, the memory capabilities of the hand-held device, the data transfer rate between the host and hand-held and the processing capabilities of each. Data transfer between the host and the hand-held device can take a number of forms. Transfer can occur via the tethered coupling, or via wireless communication using any number of different protocols such as Bluetooth of WiFi to name a few.

Continuing with the example, once the to-be-printed data is selected, formatted and transferred from the host to the hand-held device, the hand-held device is switched into its printer mode. This may occur automatically upon receipt of a predetermined indicator from the host application, or manually through user interaction. In print mode, the hand-held printer operates as a printer and user movement across the print medium is used to control the ejection of ink during the print operation, instead of controlling the cursor as occurs in the mouse mode. Using the print mode, the user prints the destination address and corresponding map image that was captured from applications running on the host.

In some embodiments, another mode of operation for obtaining or pre-selecting the information to be printed is to use a “click and drag” mouse function. As is known to those skilled in the art, a computer mouse detects physical motion and translates such motion into motion of a cursor on the computer monitor screen. In such an operation the mouse-printer 100 is used to select a point on the computer screen 11 when in the mouse mode of operation, and a box or lasso is formed to encompass the information which is to be printed. Dragging the mouse over the desired information to be printed to select pixel data can be transferred to the mouse-printer 100 for printing by right clicking this selection and using the option that instructs the user to “print selection to hand-held printer”.

The printer driver then may take either a screen capture of the selected area, or a user may highlight the desired text on the screen and copy the text content and format in the usual manner by which textual information is copied and pasted from one location or program to another, and couple the information for printing operation. Because a hand-held printer can only print one sheet at a time before the user is required to set up the next sheet of paper or medium for receiving the captured information, when such information is received by the mouse-printer 100 the user simply aligns the hand-held printer with the print receiving medium and activates the “print” button to begin printing.

An application for which this invention is particularly well suited is the preparation of mailing labels for packages. A user first selects mailing address text from the computer screen 11, and then takes the mouse-printer 100 over to a package and upon switching to the “printer” mode of operation prints the captured information onto the package. Such an operation is easy and straightforward, and does not require a special printable label or re-formatting of the information before placing it onto the package.

An additional application is the use of the copy board function, or “stacking” or “layering” selected information. For example a user could select a picture, a name and an address from the computer screen 11, and transfer each of these pre-selected portions of the information displayed on the screen to the copy board. Upon placing the mouse-printer 100 in the “print” mode these selected portions can be printed seriatim on a single page, forming a personalized custom printout of selected information from the computer screen display.

In the event the user desires to print a repetitive pattern, such as used for a border, the user can copy one or more particular patterns from patterns displayed on the computer screen 11 in a desired order and store the combination on a copy board. After capturing and storing this information in the “mouse” mode, when the mouse-printer 100 is switched to the “printer” mode these patterns would be saved and printed in a “play list” manner. Such graphical content would be stored on the computer, along with the play list, so that the user may select and print this information at any time in the future.

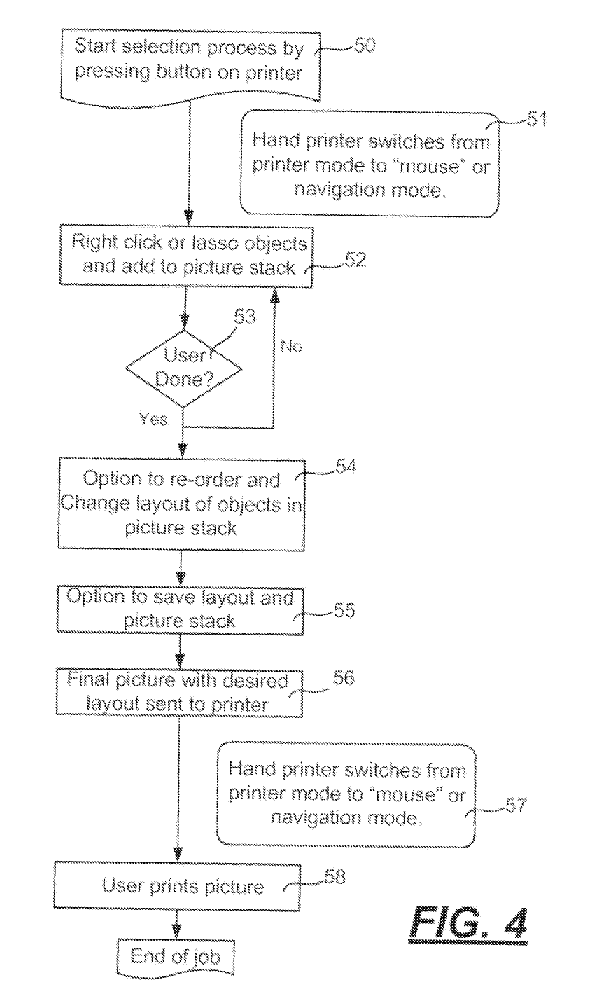

Referring now to FIG. 4, there is illustrated a flow diagram, in accordance with one embodiment of the invention, for operation of the mouse-printer 100 to capture the information to be printed, and then print the information so captured. To begin operation 50, the mouse-printer 100 is switched 51 from “printer” mode of operation into “mouse” mode of operation. In “mouse” mode of operation the information displayed on a computer screen 11 is highlighted, or “right clicked” 52 to capture the information from the computer screen which is to be printed. This may be a single capture or a multiple capture as previously described.

When the user is done 53 capturing the desired information, the user may arrange or process the information in the format desired for printing 54, and the user may save this information for future use 55. When the material is in the final form for printing, the information is transmitted for printing 56. The mouse-printer 100 is then switched 57 from “mouse” or navigation mode of operation into “printer” mode of operation.

The captured, arranged and final form desired for printing is then printed 58 by the mouse-printer 100 onto the desired print receiving medium.

As described herein all of the foregoing embodiments are examples, and it is contemplated that, and it will be apparent to those skilled in the art from the preceding description and the accompanying drawings, that modifications and/or changes may be made to the embodiments described in the disclosure. Accordingly, it is expressly intended that the foregoing description and the accompanying drawings are illustrative of exemplary embodiments only, not limiting thereto, and that the true spirit and scope of the present disclosure be determined by reference to the appended claims.

What is claimed is:

1. A hand-held printing device, comprising:
a housing;
a print head disposed in said housing, having a plurality of nozzles for ejecting ink onto a print medium;
at least one sensor configured to capture data indicative of a location of the device as the hand-printing device is manually moved across a surface;
a controller that processes location data received from the sensor; and
an interface capable of electronic communication with a host device;
wherein the controller is capable of operating in at least two modes, a first mode in which the location data from the at least one sensor is processed by the controller and sent to the host device via the interface, the location data being used by the host device to control a cursor, and a second mode in which the location data is processed by the controller and used to generate instructions indicating to the print head when to eject ink.

2. The device of claim 1, wherein the interface between the hand-held printing device and host device is a universal serial bus (USB) port.

3. The device of claim 2, wherein the hand-held printing device is configured as a two distinct USB subdevices.

4. The device of claim 1, wherein the host device treats the location data received the hand-held printing device as a mouse when the hand-held printing device operates in the first mode, and where further the host device treats the location data received from the hand-held printing device as a printer when the hand-held printing devices operates in the second mode.

5. The device of claim 1, wherein the interface between the host device and hand-held printing device is wireless.

6. The device of claim 1, further comprising a mode activator that allows a user an ability to manually switch between the first and second modes.

7. The device of claim 1, wherein the controller is additionally configured to switch between the first and second modes in response to a signal received from the host device.

8. The device of claim 1 further comprising at least two buttons disposed adjacent one another on the housing; wherein when the hand-printer device is operating in the first mode, an activation of the of the left button sends a signal to the host that the host interprets as a left-click of a mouse; and wherein further when the hand-printer device is operating in the first mode, an activation of the right button sends a signal to the host that the host interprets as a right-click of a mouse.

9. The device of claim 1, further including a memory area disposed in the housing; wherein the controller is additionally configured to receive print data from an application running on the host and to store the print data in the memory area.

10. A method of operating a hand-held printer that is configured to operate in a mouse mode and a print mode, the method comprising:
while in mouse mode, capturing an image of a surface from one or more sensors disposed on the hand-held printer and processing the image data to generate data indicative of a location and a direction of movement;
formatting the location and movement data to appear as data generated by a computer mouse;
transmitting the formatted data to a host device;
repeating the previous steps in response to a movement of the hand-held printer over a surface;
switching the hand-printer to the print mode;
capturing new image data from the one or more sensors and processing the new image data to track the movement of the hand-held printer over a print medium;
generating print instructions based at least in part on the new image data; and
using the print instructions to print an image as the hand-held printer moves over the print medium.

11. The method of claim 10, wherein the step of transmitting the formatted data occurs over a USB interface.

12. The method of claim 10, wherein the step of transmitting the formatted data occurs via a wireless interface.

13. The method of claim 10, further comprising:
receiving a user input on the hand-held printer;
formatting the user input such that when the input is received by the host, the input will be processed as a left-click or a right-click of a mouse; and
transmitting the formatted input to the host.

14. The method of claim 10, wherein the step of switching the hand-printer to the print mode occurs in response to a manual input received at the hand-printer device.

15. The method of claim 10, wherein the step of switching the hand-printer to the print mode occurs automatically in response to a signal received from the host.

16. The method of claim 10, further comprising:
receiving print data from the host while the hand-printer is in the mouse mode; and
storing the print data in a memory associated with the hand-printer.

17. The method of claim 16, wherein the print instructions that are generated in the print mode are based at least in part data stored in the memory.

18. The method of claim 10, further comprising:
receiving print data from the host while the hand-printer is in the print mode;
storing the print data in a memory; and
using the print data to generate the print instructions.

19. Apparatus for capturing desired information from a computer display screen and printing said information with a hand-held printer comprising:
display means for displaying information on a computer screen having in part information which is to be printed with a hand-held printer;
selector means for selecting that portion of the displayed information which is desired to be printed;
capture means for capturing for further processing that desired portion of the displayed information which has been selected for printing;
communication means for communicating said captured information to a hand-held printer; and
hand-held printing means for printing said captured information.
